(19) United States
(12) Patent Application Publication
(10) Pub. No.: US 2005/0287277 A1
(43) Pub. Date: Dec. 29, 2005

(54) Reheatable batter product having structure to facilitate separation

(76) Inventors: Alexander N. Hopkins, Minneapolis, MN (US); Steven W. Peplinski, Bloomington, MN (US); Barrie R. Froseth, Plymouth, MN (US)

Correspondence Address: GENERAL MILLS, INC., P.O. BOX 1113, MINNEAPOLIS, MN, 55440, US

(21) Appl. No.: 11/148,663

(22) Filed: Jun. 9, 2005

Related U.S. Application Data
(60) Provisional application No. 60/578,710, filed on Jun. 10, 2004.

(51) Int. Cl. A23L 1/00

(52) U.S. Cl. 426/594

(57) ABSTRACT

A toastable food product prepared from a cooked batter having flour, a leavening agent and water. The cooked batter includes a first portion, a second portion, a first connective web, and at least one tab member. The first portion has a first thickness, and the second portion has a second thickness substantially equal to the first thickness. The first connective web connects the first portion and the second portion. The connective web has a third thickness less than the first thickness. The at least one tab member extends across the first connective web to connect the first portion and the second portion, and to provide structural rigidity to the cooked batter.

### REFERENCE TO RELATED APPLICATIONS

This application claims the benefit of priority under 35 U.S.C. § 119(e)(1) of a provisional patent application, Ser. No. 60/578,710, filed Jun. 10, 2004, which is incorporated herein by reference in its entirety.

### FIELD OF THE INVENTION

The invention relates to reheatable food products. More particular, the invention relates to farinaceous food products having structure that facilitates both toasting the food product and separating the food product into a plurality of smaller food articles.

### BACKGROUND OF THE INVENTION

Reheatable food products such as, for example, frozen waffles, frozen French toast and the like have become increasingly popular food products due to their quick, convenient nature. Generally, the appeal of frozen, reheatable food products lies in the fact that the food products can be quickly heated, by, for example, microwaving, toasting or the like, to obtain a product that has taste and texture properties similar to food items made from scratch.

Reheatable food products such as, for example, French toast, waffles, pastries and the like, can be formed from a batter or a dough. In general, batters and doughs can have different chemical and physical properties. For example, batters can have flow properties and can incorporate air during mixing, while doughs can be elastic due to gluten interactions.

In the food industry, there has been a trend to develop easily prepared, reheatable items that can be consumed without the use of utensils such as forks and/or knives. For example, food products such as chicken nuggets, pizza pockets and the like can be easily prepared and consumed without the use of utensils, which makes these types of food products both convenient and quick food sources. Additionally, hand held food products can be desirable since it is easier for young children to consume products that do not require the use of a fork and/or knife.

It can be difficult to produce hand held reheatable food products, since smaller food products can be difficult to remove from, for example, a toaster and/or can fall apart, collapse or fold during manufacturing or reheating. Furthermore, scoring a reheatable food product to facilitate separation of the food product into smaller portions can reduce the rigidity of the food product such that the food product can fall apart, collapse or fold during reheating of the food product. Falling apart, folding or collapsing of the food product within, for example, a toaster is generally undesirable since it can lead to a toasted product having uneven heating that ranges from under heated to overheated, or potentially fires in the toaster itself.

Due to the number of consumers who purchase reheatable food products, it would be desirable to provide a reheatable food product that has suitable rigidity to prevent the food product from collapsing during heating and can be easily separated into smaller portions.

### SUMMARY OF THE INVENTION

In one aspect, the invention pertains to a reheatable food product prepared from a cooked batter made from flour, a leavening agent and water. The cooked batter can include a first portion, a second portion, a first connective web and at least one tab member.

In some embodiments, the first portion can have a first thickness, and the second portion can have a second thickness that is substantially equal to the first thickness. Additionally, the first connective web can connect the first portion and the second portion. Generally, the connective web has a third thickness that is less than the first thickness.

A tab member can extend across the first connective web to connect the first portion and the second portion, and to provide structural rigidity to the cooked batter. In some embodiments, the tab member can have a thickness that is substantially equal to the first thickness.

### BRIEF DESCRIPTION OF THE FIGURES

FIG. 1 is a perspective view of a toastable food product according to an embodiment of the present invention.

FIG. 2 is a cross-sectional view of the toastable food product taken along a line 2-2 in FIG. 1.

FIG. 3 is a top view of an alternate configuration of the toastable food product.

### DETAILED DESCRIPTION OF THE INVENTION

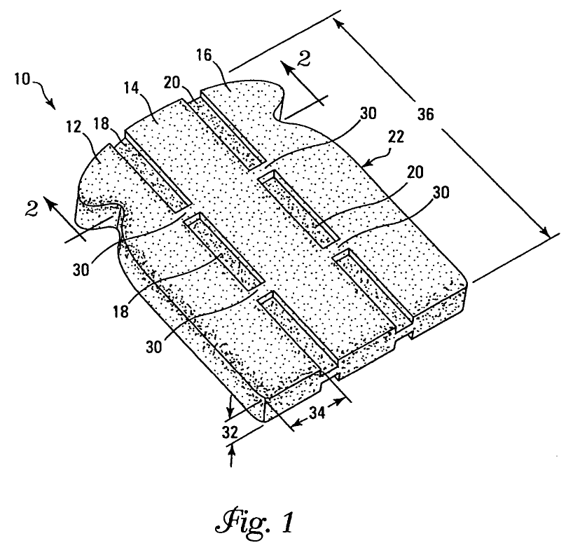

The invention is directed to a reheatable food product as generally illustrated at 10 in FIG. 1. In general, the food products described herein can be reheated using a variety of thermal processes, such as, for example, microwaving, convective oven heating, toasting or combinations thereof. For convenience, an embodiment where the food product is designed to be toasted is described throughout the remainder of this application, although such food products can be prepared for consumption by any other thermal process.

A toastable food product 10 generally includes a first section 12, a second section 14, a third section 16, a first connective web 18 and a second connective web 20. The first connective web 18 extends between the first section 12 and the second section 14. The second connective web 20 extends between the second section 14 and the third section 16.

A toastable food product 10 can have a size that is similar to a conventional slice of toast. The toastable food product 10 also has sufficient structural rigidity to facilitate toasting in a conventional toaster where the product is typically in a vertical orientation during the toasting process. The structure of a toastable food product 10 facilitates separation into smaller pieces to facilitate consumption, with or without utensils. In certain embodiments, the product 10 can be easily separated by children who typically have less strength and finger agility than adults. Separated portions of the product can be dimensioned for convenient consumption (e.g., bite-size) or sized so as to be considered a “finger food” to allow smaller children to feed themselves.

A periphery 22 of the toastable food product 10 can be shaped such that the toastable food product 10 has a bread-like appearance. However, one of ordinary skill in the art will appreciate that no particular periphery shape of the toastable food product 10 is required by the invention, and that additional and alternative periphery shapes of the toastable food product 10 can be provided. For example, the product can be square, rectangular, round, polygonal or any other shape.

First section 12, second section 14 and third section 16 can each have similar thicknesses 32, widths 34 and lengths 36. The thickness can be about 0.25 to about 1.5 inches, or, it can be about 0.4 inches to about 1 inch. The width can be about ½ of an inch to about 2 inches. The length can be about 2 to about 4 inches.

Forming first section 12, second section 14, and third section 16 with the preceding dimensions facilitates separation of the product into edible portions. Conveniently, the portions can then be dipped into containers such as cups that hold sweeteners or syrup.

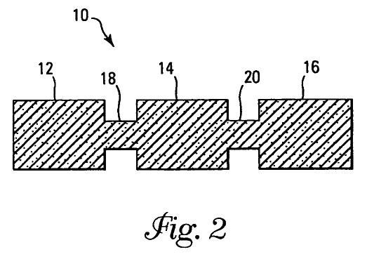

First connective web 18 and second connective web 20 can each have a thickness less than the thickness of first section 12, second section 14 and third section 16. Designing food product such that first connective web 18 and second connective web 20 have a reduced thickness relative to separable portions 12, 14, 16, facilitates tearing along connective webs 18, 20 to separate a portion of the toastable food product 10 into individual strips or sticks. The thickness of the first connective web 18 and the second connective web 20 can be about 1/16 to about 3/16 of an inch. The reduced thickness of connective webs 18, 20 relative to separable sections 12, 14, 16 is shown in FIG. 2, which is a cross-sectional view of FIG. 1 taken along line 2-2.

Toastable food product 10 includes at least one tab member 30 that extends across connective webs 18, 20 and connect adjacent sections 12, 14, 16 to enhance the structural rigidity of the toastable food product 10. Product 10 can be structured so that it resists folding over onto itself or collapsing during manufacturing, toasting or handling. Preventing the toastable food product 10 from collapsing during toasting provides uniform toasting of the food product 10 and provides a final toasted food product 10 having consistent taste and texture properties. Advantageously, tab members of food product 10 can improve the manufacturing tolerances of batter-based divideable food products.

A plurality of tab members 30 can be used to provide desired structural rigidity. The actual number of tab members may be higher for thinner food products and can be lower for thicker food products. Additionally, the particular batter composition used to form the food product can influence the number of tab members employed. The thickness of the tab members 30 can be substantially equal to the thickness of the adjacent separable sections 12, 14, 16 that the tab members 30 connect.

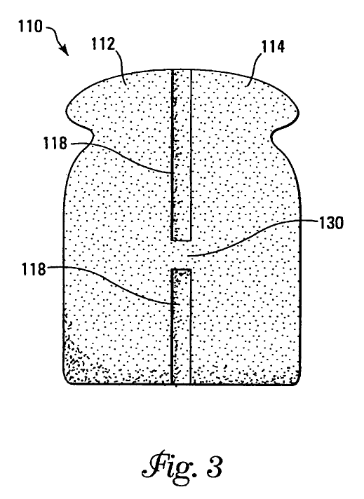

Alternative embodiments of the invention include configurations where the food product 10 comprises two, four, five, six or more separable portions. For example, FIG. 3 shows an embodiment of a toastable food product 110 separable into two portions. The product has a first portion 112, a second portion 114 and a first connective web 118 that connects first portion 112 to second portion 114. Additionally, food product 110 can have at least one tab member 130 extending across connective web 118 to connect first portion 112 and second portion 114.

Toastable food product 110 also includes a tab member 130 extending across first connective web 118. Tab member 130 can have a thickness approximately the same as the thicknesses of the first portion 112 and the second portion 114.

The toastable food product 10 of the invention can be prepared from any farinaceous food product in which it can be desired to provide structure that both facilitates toasting and handling of the food product 10 and separating the food product 10 into a plurality of smaller portions. The food product 10 can be prepared from a cooked batter such as, for example, a waffle batter, a French toast batter or the like.

In general, the batter of the present invention can comprise water, flour, a leavening agent, and optional other ingredients to produce desired texture, flavor and appearance. In some embodiments, the cooked batter can be a French toast batter prepared from water, wheat flour, oil, sweetening agents, whey, leavening agents, salt, flavor additives, color additives and egg. Water can be provided in the batter at a level of about 30 percent by weight to about 60 percent by weight, and can also be provided at a level of about 45 percent by weight to about 50 percent by weight. Wheat flour can be present in the batter at a level of about 25 to about 55 percent by weight, and in other embodiments at a level of about 35 percent by weight to about 45 percent by weight. Oil can be provided in the batter at a level of less than about 15 percent by weight. In one embodiment, oil can be provided at a level of about 5 percent by weight. Sugar or other sweetening agents such as dextrose, fructose or corn syrups can be provided in the batter at a level of less than about 20 percent by weight, and in some embodiments can be provided at a level of less than about 10 percent by weight.

In some embodiments, whey can be provided in the batter at a level of less than about 8 percent by weight. Whey can also be provided at a level of about 2 percent by weight. Leavening agents can be present in the batter at a level of about 1 percent by weight to about 5 percent by weight. A leavening agent can also be present at a level of about 2 percent by weight. Salt can be provided in the batter at a level of less than about 1 percent by weight, and also at a level of less than about 0.5 percent by weight. Flavor additives can be provided in the batter at a level of up to about 5 percent by weight. In some embodiments, egg can be provided in the batter at a level of up to about 5 percent by weight, while in other embodiments egg can be present at a level of about 0.5 percent by weight.

In general, the oils used in the batters of the invention can be any food grade oil or fat. Suitable oils include, for example, vegetable oils (i.e. soybean, cottonseed, canola, palm), butter, margarine, animal fats (i.e. beef tallow, lard) and combinations thereof. The oils can be hydrogenated, partially hydrogenated, or unhydrogenated.

The leavening agents employed in the batter for the product can be any food grade combination of an acid source and a base source that produce gas when hydrated and mixed. Suitable base sources include, for example sodium bicarbonate, and suitable acid sources include, for example, sodium aluminum phosphate (SALP), sodium acid pyrophosphate (SAPP), monocalcium phosphate (MCP), and combinations thereof. Yeast can also be used as a leavening agent.

The flavor additives can optionally be added to a batter formulation. The flavor additive(s) can be any food grade flavor ingredient including, for example, cinnamon, ginger, nutmeg, allspice, vanilla, maple, fruit pieces such as, for example, blue berries, strawberries, raspberries, fruit extracts, chocolate, nuts, colorings, preservatives such as, for example, sorbic acid and benzoic acid, candy pieces, cereal pieces, a fiber source and combinations thereof.

Additional oils and acid sources can also be optionally added. Suitable batter compositions are described in U.S. Pat. No. 6,391,366 to Boldon, entitled “Soft Frozen Batter For Baked Goods And Method Of Preparation,” and in U.S. Pat. No. 5,614,240 to Young, entitled “Method Of Producing A Baked Product Having A Sliced Appearance,” both of which are hereby incorporated by reference herein.

To form the toastable food products of the invention, dry ingredients such as, for example, flour, sugar and leavening agents can be blended together using a mechanical mixer to form a dry ingredient mixture. A portion or all of the oil used in the formulation can then be added to the dry ingredient mixture and blended by mechanical mixing to form a dry ingredient/oil premix.

The dry ingredient/oil premix can then be combined with water, additional oil and optional flavor elements and mixed by a mechanical mixer to form a batter. In some embodiments, the batter can be deposited, by pouring or the like, onto the bottom half of a forming member such as, for example, a cooking grid, and subsequently the top half of the cooking grid can be placed over the batter to enclose the batter. Upon enclosure, the grid then forms a pattern on at least one major surface of the product as it cooks.

Optionally, the outside surface of the dough and/or the inside surface of the cooking grid can be coated with a release agent, for example an oil. The cooking grid can be heated at a temperature from about 225° F. to about 475° F., for about 2-5 minutes to form a cooked batter product.

Suitable cooking grids, generally comprising one or more forming members, for making toastable food products are designed such that desired structural elements such as, for example, channels and tab members are formed at desired locations on the surface of the cooked batter product. In one embodiment, the cooking grids can be designed to form a desired pattern or design into one surface of the batter to provide the structure that facilitates portionability or separability. If desired, the cooking grids can have structure to form desired patterns or designs on multiple surfaces of the batter.

In one embodiment, the invention pertains to a kit comprising at least one farinaceous article, such as, for example, the product shown in FIGS. 1-3, and at least one packaged container comprising a sweetened substance. A kit can include a plurality of farinaceous articles as well as a plurality of packaged containers holding a sweetened substance. The kits can be packaged such that each farinaceous article has a corresponding packaged container comprising a sweetened substance. In one embodiment, the sweetened substance can comprise syrup. In other embodiments, the sweetened substance can comprise chocolate syrup, cinnamon powder, butterscotch syrup, powdered sugar, sweet and condensed milk and combinations thereof.

The embodiments above are intended to be illustrative and not limiting. Additional embodiments are within the claims. Although the invention has been described with reference to particular embodiments, workers skilled in the art will recognize that changes may be made in form and detail without the departing from the spirit and scope of the invention.

1. A reheatable food product prepared from a cooked batter comprising flour, a leavening agent and water, wherein the cooked batter comprises:
a first portion having a first thickness;
a second portion having a second thickness substantially equal to the first thickness;
a first connective web connecting the first portion and the second portion, the connective web having a third thickness less than the first thickness; and
at least one tab member extending across the first connective web such that the at least one tab member connects the first portion and the second portion to provide structural rigidity to the cooked batter.

2. The reheatable food product of claim 1, wherein the cooked batter further comprises a third portion adjacent to the second portion having a thickness substantially equal to the first thickness.

3. The reheatable food product of claim 2, wherein the cooked batter further comprises a second connective web connecting the second portion and the third portion, the second connective web having a thickness less than the first thickness.

4. The reheatable food product of claim 3, further comprising at least one tab member extending across the second connective web to connect the second portion and the third portion.

5. The reheatable food product of claim 4, wherein the tab member extending across the second connective web has a thickness substantially equal to the first thickness.

6. The reheatable food product of claim 1, wherein the first thickness can be from about 0.25 inches to about 1.5 inches.

7. The reheatable food product of claim 1, wherein the third thickness can be about 1/16 of an inch to about 3/16 of an inch.

8. The reheatable food product of claim 1, wherein the at least one tab member comprises two tab members extending across the first connective web to connect the first portion and the second portion.

9. The reheatable food product of claim 1, wherein the cooked batter comprises from about 25 percent by weight to about 55 percent by weight wheat flour.

10. The reheatable food product of claim 1, wherein the cooked batter comprises from about 1 percent by weight to about 5 percent by weight leavening agent.

11. The reheatable food product of claim 1, wherein the cooked batter comprises from about 30 percent by weight to about 60 percent by weight water.

12. The reheatable food product of claim 1, wherein the sweetening agent can be present at a concentration of less than about 20 percent by weight.

13. The reheatable food product of claim 1, wherein the at least one tab member has a thickness substantially equal to the first thickness.

14. The reheatable food product of claim 1, wherein the food product comprises a toastable food product.

15. A kit comprising:
at least one farinaceous article having:
a first portion having a first thickness;
a second portion having a second thickness substantially equal to the first thickness;
a connective web connecting the first portion and the second portion, the connective web having a third thickness less than the first thickness; and
at least one tab member extending across the connective web such that the at least one tab member connects the first portion and the second portion to provide structural rigidity to the cooked batter; and
at least one packaged container comprising a sweetened substance.

16. The kit of claim 15, wherein the sweetened substance comprises syrup.

17. A method of forming a reheatable food product, the food product comprising a farinaceous article having a first surface with a first thickness, the method comprising:
pouring a batter onto a forming member;
contacting the forming member to the batter to form a pattern on the first surface of the farinaceous article, the pattern comprising a channel having at least one tab extending across the channel, wherein the channel has a second thickness which is less than the first thickness such that the channel separates the first surface into a first portion and a second portion.

18. The method of claim 17, further comprising forming a pattern on a second surface of the farinaceous article, the pattern comprising a channel having a tab extending across the channel.

19. The method of claim 17, wherein the at least one tab has a third thickness that can be substantially equal to the first thickness.

20. The method of claim 17 further comprising toasting the reheatable food product.
